(19) United States
(12) Patent Application Publication
(10) Pub. No.: US 2026/0362462 A1
(43) Pub. Date: Nov. 12, 2026

(54) COMMUNICATION

(71) Applicant: Beijing Zitiao Network Technology Co., Ltd., Beijing (CN)

(72) Inventor: Yong TIAN, Beijing (CN)

(21) Appl. No.: 19/656,761

(22) Filed: Apr. 23, 2026

(30) Foreign Application Priority Data
May 8, 2025 (CN) 202510591846.5

(51) Int. Cl. H04W 72/51; H04W 72/0453; H04W 84/12

(52) U.S. Cl. CPC H04W 72/51; H04W 72/0453; H04W 84/12

(57) ABSTRACT

According to embodiments of the present disclosure, a method, an apparatus, a device, a storage medium and a program product for communication are provided. The method includes: obtaining first capability information of a first device, the first capability information indicating at least a first wireless local area network, WLAN, channel connection state of the first device; receiving second capability information of a second device, the second capability information indicating at least a second WLAN channel connection state of the second device; and determining a WLAN channel for communication between the first device and the second device based at least on at least one of the first WLAN channel connection state or the second WLAN channel connection state.

### CROSS-REFERENCE

This application claims the benefit of CN Patent Application No. 202510591846.5, filed on May 08, 2025, entitled "METHOD, APPARATUS, DEVICE, STORAGE MEDIUM AND PROGRAM PRODUCT FOR COMMUNICATION", which is hereby incorporated by reference in its entirety.

### FIELD

Example embodiments of the present disclosure generally relate to the field of computers, and in particular, to communication.

### BACKGROUND

With the development of computer technologies, more and more devices may support transmission of service data through a wireless local area network peer to peer connection. Instead of communicating through an intermediate device such as a router, the devices communicate through a directly established link. How to improve the data transmission speed in such a communication mode is a focus of attention currently.

### SUMMARY

In a first aspect of the present disclosure, a method for communication is provided. The method includes: obtaining first capability information of a first device, the first capability information indicating at least a first wireless local area network, WLAN, channel connection state of the first device; receiving second capability information of a second device, the second capability information indicating at least a second WLAN channel connection state of the second device; and determining a WLAN channel for communication between the first device and the second device based at least on at least one of the first WLAN channel connection state or the second WLAN channel connection state.

In a second aspect of the present disclosure, an apparatus for communication is provided. The apparatus includes: an obtaining module configured to obtain first capability information of a first device, the first capability information indicating at least a first wireless local area network, WLAN, channel connection state of the first device; a receiving module configured to receive second capability information of a second device, the second capability information indicating at least a second WLAN channel connection state of the second device; and a determination module configured to determine a WLAN channel for communication between the first device and the second device based at least on at least one of the first WLAN channel connection state or the second WLAN channel connection state.

In a third aspect of the present disclosure, an electronic device is provided. The device includes at least one processor; and at least one memory being coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, wherein the computer program, when executable by a processor, implements the method of the first aspect.

In a fifth aspect of the present disclosure, a computer program product is provided. The computer program product includes computer-executable instructions that, when executed by a processor, implement the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments of the present disclosure may be implemented;

FIG. 2 illustrates a flowchart of a time sequence signaling flow of example communication according to some embodiments of the present disclosure;

FIGS. 3A-3D illustrate flowcharts of example negotiation procedures according to some embodiments of the present disclosure;

FIG. 4 illustrates a flowchart of a process for communication according to some embodiments of the present disclosure;

FIG. 5 illustrates a schematic structural block diagram of an apparatus for communication according to some embodiments of the present disclosure; and

FIG. 6 illustrates a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although certain embodiments of the present disclosure are shown in the drawings, it would be appreciated that the present disclosure may be implemented in various forms and should not be construed as being limited to the embodiments set forth herein. Instead, these embodiments are provided for a more thorough and complete understanding of the present disclosure. It would be appreciated that the drawings and embodiments of the present disclosure are only for illustrative purposes and are not intended to limit the protection scope of the present disclosure.

It should be noted that the titles of any section/sub-section provided herein are not restrictive. Various embodiments are described throughout this specification, and any type of embodiment may be included under any section/sub-section. In addition, the embodiments described in any section/sub-section may be combined with any other embodiments described in the same section/sub-section and/or different section/sub-section in any manner.

In the description of the embodiments of the present disclosure, the term "include/comprise" and similar terms thereto should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other definitions, either explicit or implicit, may be included below. The terms "first", "second" and the like may refer to different or same objects. Other definitions, either explicit or implicit, may be included below.

The embodiments of the present disclosure may involve user data, data acquisition and/or data use, etc. All of these aspects follow the corresponding laws, regulations and related provisions. In the embodiments of the present disclosure, all data collection, acquisition, processing, machining, forwarding, use, etc., are carried out on the premise that the user is aware of and confirms the same. Accordingly, when implementing the embodiments of the present disclosure, the user should be informed of and authorize the type, range of use, use scenarios, etc., of data or information that may be involved in an appropriate manner in accordance with related laws and regulations. The specific manner of informing and/or authorizing may vary according to actual situations and application scenarios, and the scope of the present disclosure is not limited in this regard.

The solutions in this specification and the embodiments, if involving personal information processing, will all be processed on the premise that there is a legal basis (for example, consent of the personal information subject is obtained, or it is necessary for the performance of a contract, etc.), and will only be processed within a specified or agreed scope. If a user refuses to process personal information other than necessary information required for basic functions, it will not affect the user's use of the basic functions.

As described above, terminal devices may transmit service data through a wireless local area network (WLAN) peer to peer (P2P) connection. Traditionally, a terminal device may also connect to a router to implement, for example, connection to the Internet. According to a traditional solution, in a concurrency mode of router connection and service data transmission connection, the terminal device needs to take, for example, time division multiplexing measures to coordinate the router connection and the service data transmission connection, which seriously affects the communication speed between the terminal devices.

In view of this, embodiments of the present disclosure provide a solution for communication. The solution includes: obtaining first capability information of a first device, the first capability information indicating at least a first wireless local area network, WLAN, channel connection state of the first device; receiving second capability information of a second device, the second capability information indicating at least a second WLAN channel connection state of the second device; and determining a WLAN channel for communication between the first device and the second device based at least on at least one of the first WLAN channel connection state or the second WLAN channel connection state.

Based on this approach, the embodiments of the present disclosure are capable of utilizing the first WLAN channel connection state of the first device and the second WLAN channel connection state of the second device to perform channel negotiation, so that the determined WLAN channel for communication between the first device and the second device is more reasonable, and the probability of the WLAN channel being interrupted by other connections of the first device/second device is reduced. Therefore, the embodiments of the present disclosure may improve the communication speed of communication between the first device and the second device based on the WLAN channel.

### Example Environment

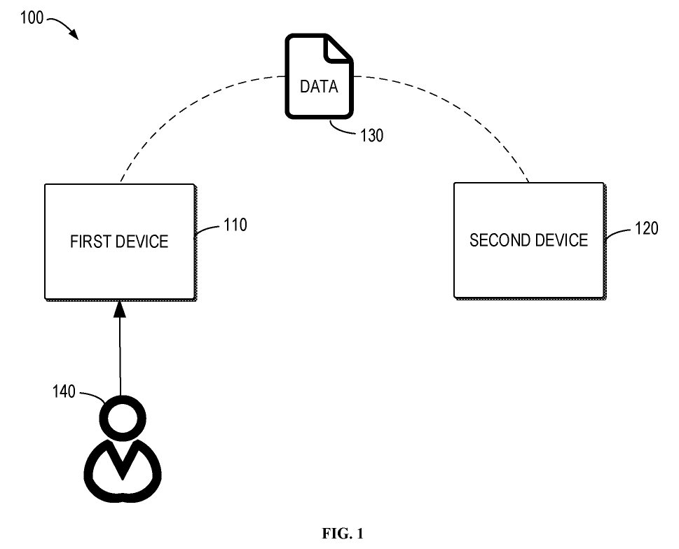

FIG. 1 illustrates a schematic diagram of an example environment 100 in which the embodiments of the present disclosure may be implemented. As shown in FIG. 1, the example environment 100 may include a first device 110 and a second device 120.

In the example environment 100, some applications and the like are installed in the first device 110. A user 140 may interact with the first device 110 via the first device 110 and/or its attached device. In some embodiments, the user 140 may also interact with the second device 120 via the second device 120 and/or its attached device. In the following, an example in which the user 140 interacts with the first device 110 via the first device 110 and/or its attached device is used.

In the environment 100 of FIG. 1, the first device 110 may send to-be-transmitted data 130 to the second device 120 or receive data 130 sent by the second device 120 via a connection between the first device 110 and the second device 120. The user 140 may interact with the first device 110 to trigger the sending or receiving of the data 130.

In some embodiments, the direct connection between the first device 110 and the second device 120 may be referred to as a peer to peer (P2P) connection. Such a P2P connection may include a wireless local area network peer to peer connection, and may also include other forms of connection methods, such as a Bluetooth connection, a near field communication (NFC) connection, an ultra-wideband (UWB) connection, and so on. In the following description, an example in which such a connection is a wireless local area network peer to peer connection is mainly described, but it would be appreciated that the embodiments of the present disclosure are not limited thereto, and may be similarly applied to any other type of P2P connection.

Taking such a connection being a wireless local area network peer to peer connection as an example, the first device 110 and the second device 120 may create a peer to peer network, and such a peer to peer network may support communications such as data transmission and resource sharing between the first device 110 and the second device 120. Further, the first device 110 may connect to such a peer to peer network to implement a peer to peer connection with the first device 110. Such data 130 may be any appropriate data that may be transmitted, and the present disclosure is not intended to limit the specific form and content of the data 130.

In some embodiments, the first device 110 may be any appropriate electronic device, such as any appropriate type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. The second device 120 may be any appropriate electronic device that supports communication with the first device 110, such as any of the above-mentioned types of mobile terminals, fixed terminals or portable terminals. In some embodiments, the second device 120 may also be a smart wearable device or the like, including a wireless headset, wireless glasses, a wireless handle, and the like. In some embodiments, the first device 110 and the second device 120 are also capable of supporting any type of user-specific interface (such as a "wearable" circuit, etc.). In some embodiments, the first device 110 and the second device 120 may also include corresponding servers, which may provide background services for applications installed on the first device 110 and the second device 120.

It would be appreciated that the structure and function of each element in the environment 100 are described for illustrative purposes only, without suggesting any limitation on the scope of the present disclosure.

Some example embodiments of the present disclosure will be further described below with continued reference to the drawings.

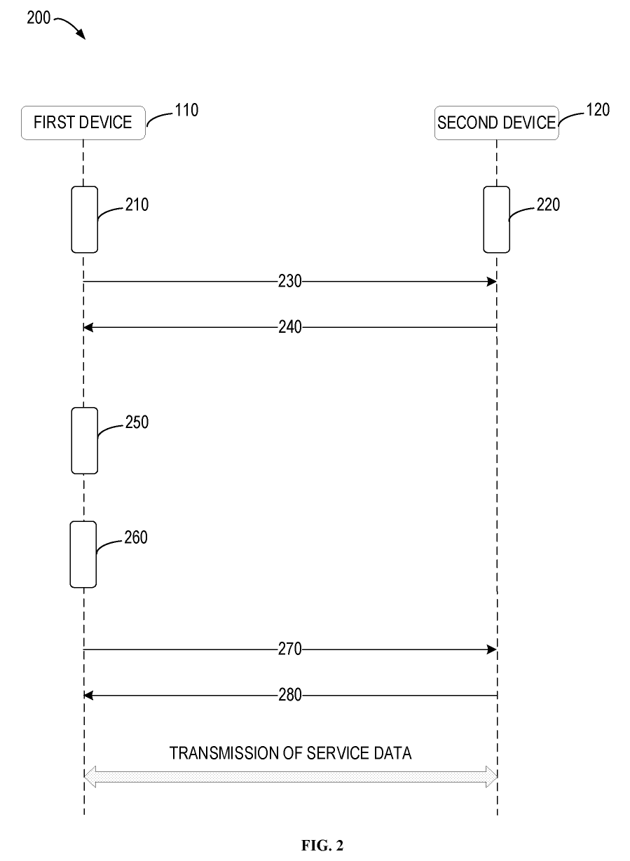

An example communication process according to some embodiments of the present disclosure will be described below with reference to FIG. 2. FIG. 2 illustrates a flowchart of a time sequence signaling flow of example communication according to some embodiments of the present disclosure, and the process 200 may be, for example, an example communication process between the first device 110 and the second device 120 shown in FIG. 1.

In some embodiments, the first device 110 obtains (210) first capability information. Such first capability information indicates at least a first wireless local area network (WLAN) channel connection state of the first device 110.

As some examples, the first device 110 may support a plurality of WLAN channels. The plurality of WLAN channels may operate at different frequency bands, such as a 5G or 2.4G frequency band. Therefore, the plurality of WLAN channels may include a 5G channel, a 2.4G channel, and so on. In the following discussion, a 5G channel and a 2.4G channel are mainly used as examples for description, but it would be appreciated that the WLAN channel may also have other operating frequency bands, which depends on the specific network configuration. The embodiments of the present disclosure may be similarly applied to WLAN channels of other frequency bands.

As an example, in the case of connecting to a router based on one WLAN channel of the plurality of WLAN channels, the first device 110 may perform data interaction with the router based on the WLAN channel. As an example, in the case that the first device 110 forms a peer to peer connection with the second device 120 based on one WLAN channel of the plurality of WLAN channels, the first device 110 may perform peer to peer data interaction with the second device 120 based on the WLAN channel.

Further, the first device 110 may determine its connection state with the WLAN channel, that is, the first WLAN channel connection state. For example, the first device 110 may determine whether at least one WLAN channel is connected to determine such a first WLAN channel connection state. For example, such a first WLAN channel connection state may indicate that the first device 110 is not connected to a WLAN channel, that the first device 110 is connected to one WLAN channel, and so on. Based on such a first WLAN channel connection state, the first device 110 may obtain first capability information indicating at least the first WLAN channel connection state. As an example, the electronic device 110 may construct the first capability information including at least the first WLAN channel connection state.

In some embodiments, the first device 110 may determine a frequency band feature of the WLAN channel supported by the first device 110, and the frequency band feature may include at least a frequency band and/or a bandwidth of the WLAN channel supported by the first device 110. Therefore, the first device 110 may further determine the first WLAN channel connection state based on the frequency band feature of the supported WLAN channel. For example, such a first WLAN channel connection state may indicate that the first device 110 is connected to one WLAN channel, and the WLAN channel is a 5G channel. For another example, such a first WLAN channel connection state may indicate that the first device 110 is connected to one WLAN channel, the WLAN channel is a 5G channel, and the WLAN channel supports a bandwidth of up to 160 MHz, etc. Based on the frequency band feature of the supported WLAN channel, the first device 110 may further obtain the first capability information that also indicates the frequency band feature of the supported WLAN channel. As an example, the electronic device 110 may construct the first capability information including at least the first WLAN channel connection state and the frequency band feature of the WLAN channel supported by the electronic device 110. As some examples, the electronic device 110 may also construct the first capability information including at least the frequency band feature of the WLAN channel supported by the electronic device 110.

In some embodiments, the second device 120 may obtain (220) second capability information. Such second capability information indicates at least a second wireless local area network (WLAN) channel connection state of the second device 120. As some examples, for the specific implementation of the second device 120 obtaining (220) the second capability information, reference may be made to the specific implementation of the first device 110 obtaining (210) the first capability information, which will not be repeated in the present disclosure.

It would be appreciated that the above-mentioned specific data items (for example, frequency band, bandwidth, etc.) mentioned in the embodiments of the present disclosure are only illustrative, and the present disclosure is not intended to limit thereto, which will not be repeated below.

Therefore, the first device 110 may obtain the first capability information, and the second device 120 may obtain the second capability information.

In some embodiments, the first device 110 may send (230) the first capability information to the second device 120. The first device 110 may also receive (240) the second capability information sent by the second device 120. Therefore, the first device 110 selects (250) a more reasonable WLAN channel for communication between the first device 110 and the second device 120 from the plurality of supported WLAN channels based on the first capability information and the second capability information.

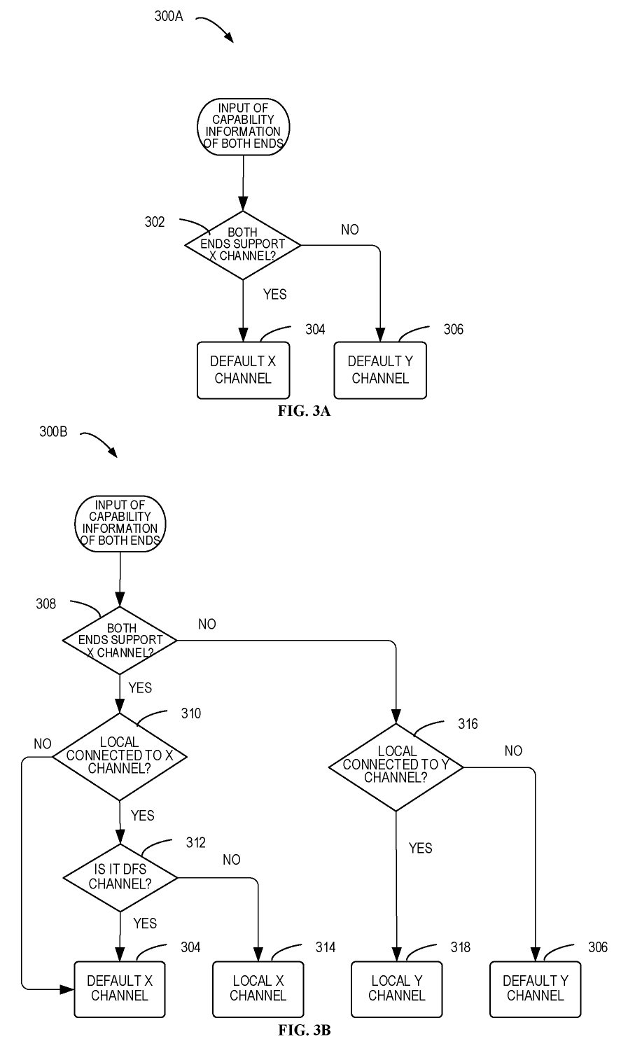

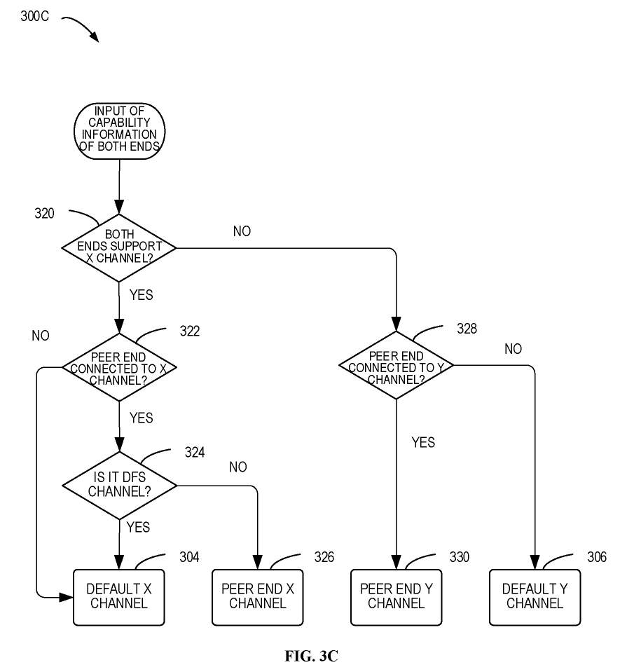

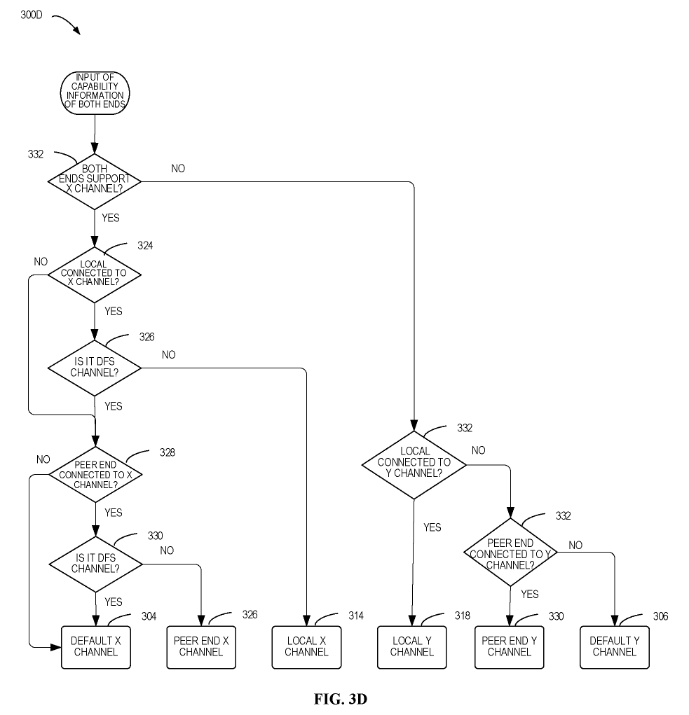

Example negotiation procedures according to some embodiments of the present disclosure will be described below with reference to FIGS. 3A-3D. FIGS. 3A-3D illustrate flowcharts of example negotiation procedures according to some embodiments of the present disclosure, and the procedures 300A to 300D may be implemented, for example, in the first device 110 shown in FIG. 1. In some embodiments, the procedures 300A to 300D may also be implemented in the second device 120 shown in FIG. 1. In the following, for the purpose of discussion, the procedures 300A to 300D are described from the perspective of the first device 110. The second device 120 may perform similar operations.

In some scenarios, the first device 110 and the second device 120 may both be not connected to a WLAN channel. Therefore, the first device 110 may determine, based on the frequency domain features supported as indicated by the first capability information and the second capability information, whether both the first device 110 and the second device 120 support a WLAN channel of a first reference frequency band.

In some embodiments, if both the first device 110 and the second device 120 support the WLAN channel of the first reference frequency band, the WLAN channel for communication between the first device 110 and the second device 120 may be a WLAN channel of the first reference frequency band. If the first device 110 does not support the WLAN channel of the first reference frequency band, and/or the second device 120 does not support the WLAN channel of the first reference frequency band, the WLAN channel for communication between the first device 110 and the second device 120 may be a WLAN channel of a second reference frequency band.

Further, in order to improve the transmission speed of data, such a second reference frequency band may be lower than the first reference frequency band. Based on this, the WLAN channel for communication between the first device 110 and the second device 120 may preferably be a channel of a higher frequency band, which may improve the data transmission speed between the first device 110 and the second device 120. As some examples, the first reference frequency band may be a 5G frequency band, and accordingly, the WLAN channel of the first reference frequency band may be a 5G channel. The second reference frequency band may be, for example, a 2.4G frequency band, and accordingly, the WLAN channel of the second reference frequency band may be a 2.4G channel.

In the following, for the convenience of discussion, the first reference frequency band is marked as X, the WLAN channel of the first reference frequency band is marked as an X channel, the second reference frequency band is marked as Y, and the WLAN channel of the second reference frequency band is marked as a Y channel. It should be noted that such marks are only for ease of description, and should not be understood as a limitation on the embodiments of the present disclosure.

According to the procedure 300A of FIG. 3A, the first device 110 may determine (302) whether both ends (the first device 110 and the second device 120) support the X channel. If so, the first device 110 may determine that the WLAN channel for communication between the first device 110 and the second device 120 is a channel 304, and such a channel 304 may be a reference WLAN channel (referred to as a default X channel) on the first reference frequency band. If not, the first device 110 may determine that the WLAN channel for communication between the first device 110 and the second device 120 is a channel 306, and such a channel 306 is a reference WLAN channel (referred to as a default X channel) on the second reference frequency band.

In some scenarios, the first device 110 may be connected to one or more WLAN channels, while the second device 120 is not connected to a WLAN channel. Therefore, the first device 110 may also determine, based on the frequency domain features supported as indicated by the first capability information and the second capability information, whether both the first device 110 and the second device 120 support the WLAN channel of the first reference frequency band. For example, as shown in FIG. 3B, the first device 110 may determine (308) whether both ends (the first device 110 and the second device 120) support the X channel.

Further, in the case that both the first device 110 and the second device 120 support the X channel, the first device 110 may determine whether the WLAN channel to which the first device 110 is connected includes a channel of the first reference frequency band. For example, as shown in FIG. 3B, the first device 110 may determine (310) whether a local (that is, the first device 110) is connected to the X channel.

In some embodiments, if the first device 110 is connected to a channel of the first reference frequency band, the first device 110 may determine the availability of the channel of the first reference frequency band. In the following, an example in which there is one channel of the first reference frequency band is used, and it would be appreciated that the first device 110 may also be connected to a plurality of channels of the first reference frequency band. For the specific implementation in such a scenario, reference may be made to the embodiments of the present disclosure, for example, one of the plurality of channels of the first reference frequency band connected to the first device 110 may be used as the channel of the first reference frequency band described below.

According to the procedure 300B of FIG. 3B, the first device 110 may determine the availability of the channel of the first reference frequency band by determining (312) whether the channel of the first reference frequency band is a dynamic frequency selection (DFS) channel. As an example, if the channel of the first reference frequency band is a DFS channel, the first device 110 may determine that the channel of the first reference frequency band is unavailable, since such a dynamic frequency selection channel needs to give way to the preferential connection of the radar. If the channel of the first reference frequency band is not a DFS channel, the first device 110 may determine that the channel of the first reference frequency band is available.

Further, if it is determined that the channel of the first reference frequency band is unavailable, the first device 110 may determine an unconnected channel 304 of the first reference frequency band as the WLAN channel for communication with the second device 120, and if the channel of the first reference frequency band is available, the first device 110 may determine the connected channel 314 of the first reference frequency band (referred to as a local X channel) as the WLAN channel for communication with the second device 120.

In some embodiments, if neither the first device 110 nor the second device 120 is connected to the channel of the first reference frequency band, the first device 110 may further determine (316) whether the local is connected to a channel of the second reference frequency band. If so, the first device 110 may determine the connected channel 318 of the second reference frequency band (referred to as a local Y channel) as the WLAN channel for communication with the second device 120.

Therefore, the first device 110 may use the channel connected to the router to transmit data to the second device 120, so as to avoid the interruption of the data transmission process with the second device 120, thereby improving the data transmission speed. In addition, based on the channel of the first reference frequency band which is preferentially connected, the data transmission speed between the first device 110 and the second device 120 may be further improved.

If it is determined that the local is not connected to the channel of the second reference frequency band, the first device 110 may determine an unconnected channel 306 of the second reference frequency band as the WLAN channel for communication with the second device 120. In this way, the embodiments of the present disclosure may ensure the normal communication between the first device 110 and the second device 120.

In some scenarios, the first device 110 may be not connected to a WLAN channel, while the second device 120 is connected to one or more WLAN channels. In the scenario that the first device 110 may be not connected to a WLAN channel, while the second device 120 is connected to one or more WLAN channels, for the specific implementation of the first device 110 determining the WLAN channel for communication with the second device 120, reference may be made to the specific implementation in the scenario that the first device 110 may be connected to one or more WLAN channels, while the second device 120 is not connected to a WLAN channel, which will not be repeated in the embodiments of the present disclosure, and only FIG. 3C is used as an example for description.

According to the procedure 300C of FIG. 3C, the first device 110 may determine (320) whether both ends (the first device 110 and the second device 120) support the X channel. If both the first device 110 and the second device 120 support the X channel, the first device 110 may further determine (322) whether the peer end (the second device 120) is connected to the X channel.

Further, if the second device 120 is connected to the X channel, the first device 110 may determine (324) whether such an X channel connected to the second device 120 is a DFS channel. If such an X channel connected to the second device 120 is a DFS channel, the first device 110 may determine that the WLAN channel for communication with the second device 120 is the channel 304, and if such an X channel connected to the second device 120 is not a DFS channel, the first device 110 may determine that the WLAN channel for communication with the second device 120 is a channel 326, and such a channel 326 may be a WLAN channel (a peer end X channel) of the first reference frequency band connected to the second device 120.

If the second device 120 is not connected to the X channel, the first device 110 may further determine (328) whether the second device 120 is connected to a Y channel. If the second device 120 is connected to the Y channel, the first device 110 may determine the channel 330 (the peer end Y channel) connected to the second device 120 as the WLAN channel for communication between the first device 110 and the second device 120. If the second device 120 is not connected to the Y channel, the first device 110 may determine an unconnected channel 306 of the second reference frequency band as the WLAN channel for communication with the second device 120, so as to ensure the normal communication between the first device 110 and the second device 120.

In some scenarios, the first device 110 and the second device 120 may both be connected to one or more WLAN channels. Therefore, the first device 110 may select a WLAN channel for communication between the first device 110 and the second device 120 from one or more WLAN channels connected to the first device 110, one or more WLAN channels connected to the second device 120, a reference WLAN channel of the first reference frequency band, and a reference WLAN channel of the second reference frequency band. A more detailed description will be given below with reference to FIG. 3D.

According to the procedure 300D of FIG. 3D, the first device 110 may determine, based on the frequency domain features supported as indicated by the first capability information and the second capability information, whether both the first device 110 and the second device 120 support the WLAN channel of the first reference frequency band. For example, as shown in FIG. 3D, the first device 110 may determine (332) whether both ends (the first device 110 and the second device 120) support the X channel.

Further, in the case that both the first device 110 and the second device 120 support the WLAN channel of the first reference frequency band, the first device 110 may determine whether the WLAN channel to which the first device 110 is connected includes the channel of the first reference frequency band. For example, as shown in FIG. 3D, the first device 110 may determine (324) whether the local (the first device 110) is connected to the X channel.

In some embodiments, if the first device 110 is connected to the channel of the first reference frequency band, the first device 110 may determine the availability of the channel of the first reference frequency band. Similarly, in the following, an example in which there is one channel of the first reference frequency band is used. As an example, the first device 110 may determine (326) whether the channel of the first reference frequency band is a DFS channel to determine the availability of the channel of the first reference frequency band. If the channel of the first reference frequency band is available, the first device 110 may determine the connected channel 314 as the WLAN channel for communication with the second device 120.

In some embodiments, if the first device 110 is not connected to the channel of the first reference frequency band, or the channel of the first reference frequency band connected to the first device 110 is unavailable, the first device 110 may further determine (328) whether the peer end (the second device 120) is connected to the X channel.

Further, if the second device 120 is connected to the X channel, similarly, in the following, an example in which the second device 120 is connected to one X channel is used. The first device 110 may determine (330) whether the X channel connected to the second device 120 is a DFS channel to determine the availability of the X channel connected to the second device 120. If the X channel connected to the second device 120 is available, the first device 110 may determine the channel 326 connected to the second device 120 as the WLAN channel for communication with the second device 120. If the channel of the first reference frequency band connected to the second device 120 is unavailable, the first device 110 may determine the channel 304 as the WLAN channel for communication with the second device 120.

In the case that the first device 110 does not support the WLAN channel of the first reference frequency band, and/or the second device 120 does not support the WLAN channel of the first reference frequency band, the first device 110 may further determine (332) whether the local is connected to a Y channel. If the first device 110 is connected to a channel of the second reference frequency band, the first device 110 may determine the channel 318 connected to the local as the WLAN channel for communication with the second device 120.

If the first device 110 is not connected to the channel of the second reference frequency band, the first device 110 may further determine (334) whether the peer end is connected to the Y channel. Further, if the second device 120 is connected to the Y channel, the first device 110 may determine the channel 330 (the peer end Y channel) connected to the second device 120 as the WLAN channel for communication between the first device 110 and the second device 120. If the second device 120 is not connected to the Y channel, the first device 110 may determine an unconnected channel 306 of the second reference frequency band as the WLAN channel for communication with the second device 120.

Further, returning to FIG. 2, in the case that the first device 110 obtains the WLAN channel for communication with the second device 120, the second device 120 may create (260) a peer to peer network for communication based on the WLAN channel, and send (270) information about such a peer to peer network to the second device 120. The second device 120 thus connects (280) to the peer to peer network created by the first device 110, so that the establishment of the peer to peer connection between the first device 110 and the second device 120 is completed. Based on this, the first device 110 and the second device 120 may communicate faster, for example, transmit service data faster.

It would be appreciated that for the specific implementation details not described in detail in some embodiments of the present disclosure, reference may be made to the corresponding description in other embodiments, which will not be repeated in the present disclosure.

Based on this approach, the embodiments of the present disclosure are capable of utilizing the first WLAN channel connection state of the first device and the second WLAN channel connection state of the second device to perform channel negotiation, so that the determined WLAN channel for communication between the first device and the second device is more reasonable, and the probability of the WLAN channel being interrupted by other connections of the first device/second device is reduced. Therefore, the embodiments of the present disclosure may improve the communication speed of communication between the first device and the second device based on the WLAN channel.

### Example Procedure

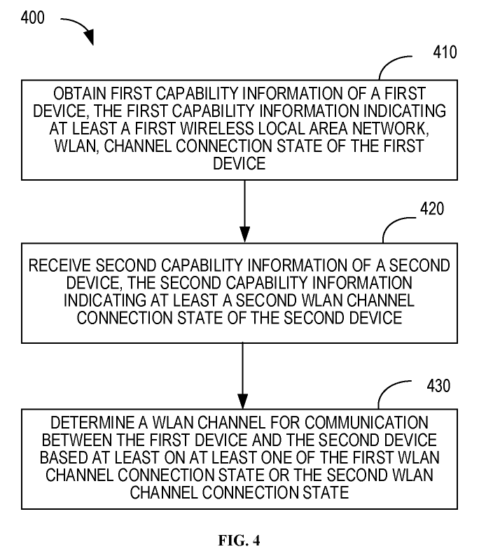

FIG. 4 illustrates a flowchart of an example communication procedure 400 according to some embodiments of the present disclosure. The procedure 400 may be implemented at the first device 110. The procedure 400 is described below with reference to FIG. 1.

At block 410, the first device 110 obtains first capability information of the first device, the first capability information indicating at least a first wireless local area network, WLAN, channel connection state of the first device.

At block 420, the first device 110 receives second capability information of a second device, the second capability information indicating at least a second WLAN channel connection state of the second device.

At block 430, the first device 110 determines a WLAN channel for communication between the first device and the second device based at least on at least one of the first WLAN channel connection state or the second WLAN channel connection state.

In some embodiments, the first capability information and the second capability information further indicate a frequency domain feature of a supported WLAN channel, the frequency domain feature including at least one of a frequency band or a bandwidth of the supported WLAN channel, and determining the WLAN channel for communication includes: determining the WLAN channel for communication further based on the frequency domain feature of the WLAN channel.

In some embodiments, determining the WLAN channel for communication includes: determining, based on the frequency domain feature, that both the first device and the second device support a WLAN channel on a first reference frequency band; and determining, based on the at least one connection state, the WLAN channel on the first reference frequency band for the communication.

In some embodiments, the first capability information and the second capability information further indicate availability of a currently connected WLAN channel on the first reference frequency band, and determining the WLAN channel on the first reference frequency band includes: determining, based on the at least one connection state, that one or both of the first device and the second device have been connected to one or more WLAN channels on the first reference frequency band; and determining, based on the availability, the WLAN channel on the first reference frequency band for communication.

In some embodiments, determining the WLAN channel on the first reference frequency band includes: determining, based on the availability, that at least one of the one or more connected WLAN channels on the first reference frequency band is available; and determining a WLAN channel in the at least one available WLAN channel on the first reference frequency band for communication.

In some embodiments, determining the WLAN channel on the first reference frequency band includes: determining, based on the availability, that the one or more connected WLAN channels on the first reference frequency band are unavailable; and determining a reference WLAN channel on the first reference frequency band for communication.

In some embodiments, determining the WLAN channel on the first reference frequency band includes: determining, based on the at least one connection state, that the first device and the second device fail to be connected to the WLAN channel on the first reference frequency band; and determining a reference WLAN channel on the first reference frequency band for communication.

In some embodiments, determining the at least one WLAN channel for communication includes: determining, based on the frequency domain feature, that the first device and the second device fail to support a WLAN channel on a first reference frequency band; and determining a WLAN channel on a second reference frequency band for communication.

In some embodiments, determining the WLAN channel on the second reference frequency band includes: determining, based on the at least one connection state, that at least one of the first device or the second device has been connected to at least one WLAN channel on the second reference frequency band; and determining a WLAN channel in the at least one connected WLAN channel on the second reference frequency band for communication.

In some embodiments, determining the WLAN channel on the second reference frequency band includes: determining, based on the at least one connection state, that the first device and the second device fail to be connected to the WLAN channel on the second reference frequency band; and determining a reference WLAN channel on the second reference frequency band for communication.

### Example Apparatus and Device

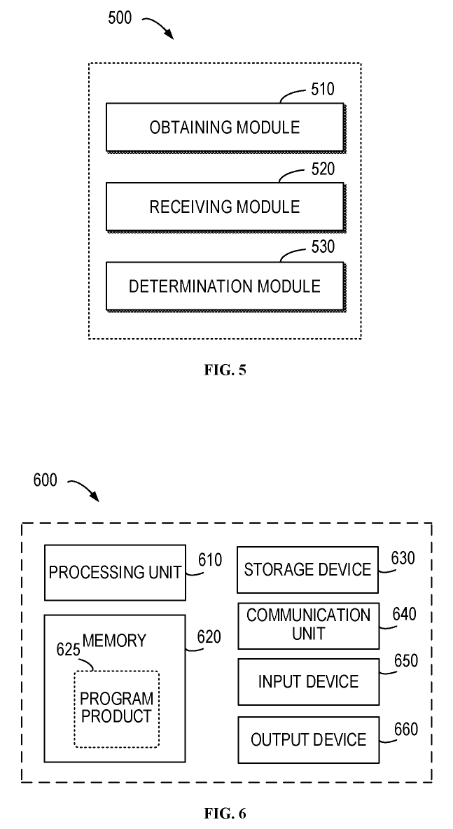

The embodiments of the present disclosure further provide a corresponding apparatus for implementing the above method or procedure. FIG. 5 illustrates a schematic structural block diagram of an example apparatus 500 for communication according to some embodiments of the present disclosure. The apparatus 500 may be implemented as or included in the first device 110 as discussed above. Each module/component in the apparatus 500 may be implemented by hardware, software, firmware, or any combination thereof.

As shown in FIG. 5, the apparatus 500 includes: an obtaining module configured to obtain first capability information of a first device, the first capability information indicating at least a first wireless local area network, WLAN, channel connection state of the first device; a receiving module configured to receive second capability information of a second device, the second capability information indicating at least a second WLAN channel connection state of the second device; and a determination module configured to determine a WLAN channel for communication between the first device and the second device based at least on at least one of the first WLAN channel connection state or the second WLAN channel connection state.

In some embodiments, the first capability information and the second capability information further indicate a frequency domain feature of a supported WLAN channel, the frequency domain feature including at least one of a frequency band or a bandwidth of the supported WLAN channel, and the determination module is further configured to: determine the WLAN channel for communication further based on the frequency domain feature of the WLAN channel.

In some embodiments, the determination module is further configured to: determine, based on the frequency domain feature, that both the first device and the second device support a WLAN channel on a first reference frequency band; and determine, based on the at least one connection state, the WLAN channel on the first reference frequency band for communication.

In some embodiments, the first capability information and the second capability information further indicate availability of a currently connected WLAN channel on the first reference frequency band, and the determination module is further configured to: determine, based on the at least one connection state, that one or both of the first device and the second device have been connected to one or more WLAN channels on the first reference frequency band; and determine, based on the availability, the WLAN channel on the first reference frequency band for communication.

In some embodiments, the determination module is further configured to: determine, based on the availability, that at least one of the one or more connected WLAN channels on the first reference frequency band is available; and determine a WLAN channel in the at least one available WLAN channel on the first reference frequency band for communication.

In some embodiments, the determination module is further configured to: determine, based on the availability, that the one or more connected WLAN channels on the first reference frequency band are unavailable; and determine a reference WLAN channel on the first reference frequency band for communication.

In some embodiments, the determination module is further configured to: determine, based on the at least one connection state, that the first device and the second device fail to be connected to the WLAN channel on the first reference frequency band; and determine a reference WLAN channel on the first reference frequency band for communication.

In some embodiments, the determination module is further configured to: determine, based on the frequency domain feature, that the first device and the second device fail to support a WLAN channel on a first reference frequency band; and determine a WLAN channel on a second reference frequency band for communication.

In some embodiments, the determination module is further configured to: determine, based on the at least one connection state, that at least one of the first device or the second device has been connected to at least one WLAN channel on the second reference frequency band; and determine a WLAN channel in the at least one connected WLAN channel on the second reference frequency band for the communication.

In some embodiments, the determination module is further configured to: determine, based on the at least one connection state, that the first device and the second device fail to be connected to the WLAN channel on the second reference frequency band; and determine a reference WLAN channel on the second reference frequency band for communication.

The units included in the apparatus 500 may be implemented in various ways, including software, hardware, firmware, or any combination thereof. In some embodiments, one or more units may be implemented using software and/or firmware, such as machine-executable instructions stored on a storage medium. In addition to machine-executable instructions or as an alternative, some or all units in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and more.

FIG. 6 illustrates a block diagram of an electronic device 600 in which one or more embodiments of the present disclosure may be implemented. It would be appreciated that the electronic device 600 shown in FIG. 6 is only illustrative, and should not constitute any limitation on the functionality and scope of the embodiments described herein. The electronic device 600 shown in FIG. 6 may be used to implement the first device 110 of FIG. 1 or the apparatus 500 of FIG. 5.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, multiple processing units execute computer-executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used for storing information and/or data and may be accessed within the electronic device 600.

The electronic device 600 may further include additional removable/non-removable, volatile/non-volatile memory medium. Although not shown in FIG. 6, it is possible to provide a disk driver for reading from or writing to a removable, non-volatile disk (such as a "floppy disk"), and an optical disk driver for reading from or writing to a removable, non-volatile optical disk. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 implements communication with other electronic devices through the communication medium. In addition, the functions of the components of the electronic device 600 may be implemented by a single computing cluster or multiple computing machines, which may communicate through communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed, the external devices such as a storage device, a display device, etc., communicate with one or more devices that enable a user to interact with the electronic device 600, or communicate with any devices (for example, a network card, a modem, etc.) that enable the electronic device 600 to communicate with one or more other electronic devices. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product tangibly stored on a non-transitory computer-readable medium and including computer-executable instructions, where the computer-executable instructions are executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, the instructions cause a computer, a programmable data processing apparatus, and/or other devices to work in a particular way, such that the computer-readable medium storing the instructions includes an article of manufacture including instructions for implementing various aspects of the functions/acts specified in one or more blocks of the flowcharts and/or block diagrams.

The computer-readable program instructions may be loaded onto a computer, other programmable data processing apparatus, or other devices, causing a series of operating steps to be performed on the computer, other programmable data processing apparatus, or other devices to produce a computer-implemented process, such that the instructions executed on the computer, other programmable data processing apparatus, or other devices implement the functions/acts specified in one or more blocks of the flowcharts and/or block diagrams.

The flowcharts and block diagrams in the drawings show the possibly implemented architectures, functions and operations of the systems, methods and computer program products according to multiple implementations of the present disclosure. In this regard, each block in the flowchart or block diagram may represent a module, program segment, or portion of an instruction, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that performs the specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications or improvements to the technology in the market, or to enable other those of ordinary skill in the art to understand the implementations disclosed herein.

1. A method for communication, comprising:
obtaining first capability information of a first device, the first capability information indicating at least a first wireless local area network, WLAN, channel connection state of the first device;
receiving second capability information of a second device, the second capability information indicating at least a second WLAN channel connection state of the second device; and
determining a WLAN channel for communication between the first device and the second device based at least on at least one of the first WLAN channel connection state or the second WLAN channel connection state.

2. The method of claim 1, wherein
the first capability information and the second capability information further indicate a frequency domain feature of a supported WLAN channel, the frequency domain feature comprising at least one of a frequency band or a bandwidth of the supported WLAN channel, and
determining the WLAN channel for the communication comprises:
determining the WLAN channel for the communication further based on the frequency domain feature of the WLAN channel.

3. The method of claim 2, wherein determining the WLAN channel for the communication comprises:
determining, based on the frequency domain feature, that both the first device and the second device support a WLAN channel on a first reference frequency band; and
determining, based on the at least one connection state, the WLAN channel on the first reference frequency band for the communication.

4. The method of claim 3, wherein
the first capability information and the second capability information further indicate availability of a currently connected WLAN channel on the first reference frequency band,
determining the WLAN channel on the first reference frequency band comprises:
determining, based on the at least one connection state, that one or both of the first device and the second device have been connected to one or more WLAN channels on the first reference frequency band; and
determining, based on the availability, the WLAN channel on the first reference frequency band for the communication.

5. The method of claim 4, wherein determining the WLAN channel on the first reference frequency band comprises:
determining, based on the availability, that at least one of the one or more connected WLAN channels on the first reference frequency band is available; and
determining a WLAN channel in the at least one available WLAN channel on the first reference frequency band for the communication.

6. The method of claim 4, wherein determining the WLAN channel on the first reference frequency band comprises:
determining, based on the availability, that the one or more connected WLAN channels on the first reference frequency band are unavailable; and
determining a reference WLAN channel on the first reference frequency band for the communication.

7. The method of claim 3, wherein determining the WLAN channel on the first reference frequency band comprises:
determining, based on the at least one connection state, that the first device and the second device fail to be connected to the WLAN channel on the first reference frequency band; and
determining a reference WLAN channel on the first reference frequency band for the communication.

8. The method of claim 2, wherein determining the at least one WLAN channel for the communication comprises:
determining, based on the frequency domain feature, that the first device and the second device fail to support a WLAN channel on a first reference frequency band; and
determining a WLAN channel on a second reference frequency band for the communication.

9. The method of claim 8, wherein determining the WLAN channel on the second reference frequency band comprises:
determining, based on the at least one connection state, that at least one of the first device or the second device has been connected to at least one WLAN channel on the second reference frequency band; and
determining a WLAN channel in the at least one connected WLAN channel on the second reference frequency band for the communication.

10. The method of claim 8, wherein determining the WLAN channel on the second reference frequency band comprises:
determining, based on the at least one connection state, that the first device and the second device fail to be connected to the WLAN channel on the second reference frequency band; and
determining a reference WLAN channel on the second reference frequency band for the communication.

11. An electronic device, comprising:
at least one processor; and
at least one memory coupled to the at least one processor and storing instructions for execution by the at least one processor, the instructions, when executed by the at least one processor, causing the electronic device to perform operations comprising:
obtaining first capability information of a first device, the first capability information indicating at least a first wireless local area network, WLAN, channel connection state of the first device;
receiving second capability information of a second device, the second capability information indicating at least a second WLAN channel connection state of the second device; and
determining a WLAN channel for communication between the first device and the second device based at least on at least one of the first WLAN channel connection state or the second WLAN channel connection state.

12. The electronic device of claim 11, wherein
the first capability information and the second capability information further indicate a frequency domain feature of a supported WLAN channel, the frequency domain feature comprising at least one of a frequency band or a bandwidth of the supported WLAN channel, and
determining the WLAN channel for the communication comprises:
determining the WLAN channel for the communication further based on the frequency domain feature of the WLAN channel.

13. The electronic device of claim 12, wherein determining the WLAN channel for the communication comprises:
determining, based on the frequency domain feature, that both the first device and the second device support a WLAN channel on a first reference frequency band; and
determining, based on the at least one connection state, the WLAN channel on the first reference frequency band for the communication.

14. The electronic device of claim 13, wherein
the first capability information and the second capability information further indicate availability of a currently connected WLAN channel on the first reference frequency band,
determining the WLAN channel on the first reference frequency band comprises:
determining, based on the at least one connection state, that one or both of the first device and the second device have been connected to one or more WLAN channels on the first reference frequency band; and
determining, based on the availability, the WLAN channel on the first reference frequency band for the communication.

15. The electronic device of claim 14, wherein determining the WLAN channel on the first reference frequency band comprises:
determining, based on the availability, that at least one of the one or more connected WLAN channels on the first reference frequency band is available; and
determining a WLAN channel in the at least one available WLAN channel on the first reference frequency band for the communication.

16. The electronic device of claim 14, wherein determining the WLAN channel on the first reference frequency band comprises:
determining, based on the availability, that the one or more connected WLAN channels on the first reference frequency band are unavailable; and
determining a reference WLAN channel on the first reference frequency band for the communication.

17. The electronic device of claim 13, wherein determining the WLAN channel on the first reference frequency band comprises:
determining, based on the at least one connection state, that the first device and the second device fail to be connected to the WLAN channel on the first reference frequency band; and
determining a reference WLAN channel on the first reference frequency band for the communication.

18. The electronic device of claim 12, wherein determining the at least one WLAN channel for the communication comprises:
determining, based on the frequency domain feature, that the first device and the second device fail to support a WLAN channel on a first reference frequency band; and
determining a WLAN channel on a second reference frequency band for the communication.

19. The electronic device of claim 18, wherein determining the WLAN channel on the second reference frequency band comprises:
determining, based on the at least one connection state, that at least one of the first device or the second device has been connected to at least one WLAN channel on the second reference frequency band; and
determining a WLAN channel in the at least one connected WLAN channel on the second reference frequency band for the communication.

20. A non-transitory computer-readable storage medium having a computer program stored thereon, wherein the computer program, when executed by a processor, implements operations comprising:
obtaining first capability information of a first device, the first capability information indicating at least a first wireless local area network, WLAN, channel connection state of the first device;
receiving second capability information of a second device, the second capability information indicating at least a second WLAN channel connection state of the second device; and
determining a WLAN channel for communication between the first device and the second device based at least on at least one of the first WLAN channel connection state or the second WLAN channel connection state.
